(19) United States
(12) Patent Application Publication
(10) Pub. No.: US 2008/0272929 A1
(43) Pub. Date: Nov. 6, 2008

(54) Av Appliance Operating System

(75) Inventor: Hiroshi Nakamura, Saitama (JP)

Correspondence Address: SUGHRUE-265550, 2100 PENNSYLVANIA AVE. NW, WASHINGTON, DC, 20037-3213, US

(73) Assignee: Pioneer Corporation, Tokyo (JP)

(21) Appl. No.: 11/910,055

(22) PCT Filed: Mar. 6, 2006
(86) PCT No.: PCT/JP2006/304251

§ 371 Date: Jan. 24, 2008

(30) Foreign Application Priority Data
Mar. 28, 2005 (JP) 2005-092849

(51) Int. Cl. G08C 19/16

(52) U.S. Cl. 340/825.57

(57) ABSTRACT

A low cost pointing device is desirable which is operable in low power consumption and is properly operable with respect to GUI of an AV appliance. In an AV appliance operating system containing a remote controller main body which is operable in an infrared communication with respect to an AV appliance equipped with a display unit 31, one pair of speakers 33, 35, and a control apparatus 39, there are provided: a pulse generating unit provided in the remote controller main body, for outputting an infrared pulse at predetermined timing; a ultrasonic wave outputting unit 63 provided in the control apparatus 39, for sequentially outputting ultrasonic waves having frequencies outside a human audio-frequency range from the one pair of speakers 33, 35, in response to an input of the infrared pulse; a response outputting unit 55 provided in the remote controller main body 41, for outputting an infrared response signal in response to a detection of the ultrasonic waves; and a calculating unit 65 provided in the control apparatus 39, for calculating a position of the remote controller main body based upon ultrasonic wave detection times at the respective speakers 33 and 35.

### TECHNICAL FIELD

The present invention is related to an AV appliance operating system.

### BACKGROUND ART

For instance, in AV (Audio Visual) appliances such as television receivers, VTRs, and CD players, infrared communications are widely utilized as wireless communications. In infrared communications, signals are transmitted/received by operating infrared communication apparatuses which are provided in main appliances (television receivers etc.) and counter appliances (infrared remote controllers etc.) (refer to, for example, patent publication 1).

As indicated in FIG. 1, such an infrared communication apparatus 1 is arranged by a transmitting/receiving unit 3 and a control unit 5.

The transmitting/receiving unit 3 is arranged by a light emitting unit 11 and a light receiving unit 17. The light emitting unit 11 is constituted by an LED 7 and an LSD driver 9. The light receiving unit 17 is constituted by a photodiode 13 and a reception amplifier 15. Also, the control unit 5 is arranged by a modulator 19 and a demodulator 21. The modulator 19 modulates transmission data so as to transfer the modulated transmission data to the light receiving unit 11. The demodulator 21 demodulates a signal received by the light receiving unit 17 and converts the demodulated signal into reception data.

Such a conventional infrared communication apparatus 1 is operated as follows: The transmission data is modulated by the modulator 19 in a pulse-width modulating method. Thereafter, the pulse-width modulated transmission data is transferred to the LED driver 9 so as to be converted into an optical signal by the LED 7. On the other hand, an optical signal transmitted from a communication counter unit is converted into an electric signal by the photodiode 13. Thereafter, the converted electric signal is amplified by the reception amplifier 15, and the amplified signal is demodulated by the demodulator 21, and then, the demodulated signal is outputted as reception data.

Patent Publication 1: JP-A-6-303452

### DISCLOSURE OF THE INVENTION

### Problems that the Invention is to Solve

Recently, there are many home-use AV appliances which require interactive operations, while operations instructed from infrared remote controllers, and the like are entered thereinto via interfaces (GUI: Graphical User Interface) using visual information such as figures. As a consequence, controllable characteristics by conventional key input type remote controllers become deteriorated in the present stage,

However, usually, there are many inconvenient points in such a case that mice and similar products thereof which are generally employed in personal computers are utilized in home living rooms, for instance, flat planes having predetermined areas such as desk top planes are required. Therefore, pointing devices which are replaceable by these mice and similar products are required.

In contract to the above-explained pointing devices, other remote controllers is proposed. That is, since this sort of remote controllers are inclined, transmission data are transmitted to main appliances. This sort of remote controllers contain, for example, angular velocity sensors (vibration gyroscopes); output voltages from the angular velocity sensors are applied to amplifying units; the amplified sensor voltages are converted into digital voltage data as digital voltage values by A/D converters; and then, the digital voltage values are outputted so as to acquire motional information. As a result, circuits of these remote controllers become complex and high cost, and power consumption thereof is increased. More specifically, in cell-driven type remote controllers, consumed cells must be frequently replaced by new cells, which lower practicability of the cell-driven type remote controllers.

As problems that the present invention is to solve, such a problem may be conceived as one example. That is, pointing devices capable of being operated with respect to GUIs of AV appliances are required, while the pointing devices are made in low cost and operable under low power consumption.

### Means for Solving the Problems

According to Claim 1 of the present invention, there is provided an AV appliance operating system including: a remote controller main body which can be operated in a wireless manner by infrared communication apparatuses provided in both a control apparatus and an AV appliance, the AV appliance being equipped with a display unit, at least one pair of speakers, and the control apparatus for performing an input control operation by GUI with employment of the display unit; a pulse generating unit that is provided in the remote controller main body, and outputs an infrared pulse at predetermined timing; an ultrasonic wave outputting unit that is provided in the control apparatus, and sequentially outputs ultrasonic waves having frequencies outside a human audio-frequency range from the one pair of speakers in response to an input of the infrared pulse; a response outputting unit that is provided in the remote controller main body, and outputs an infrared response signal in response to a detection of the ultrasonic waves; and a calculating unit that is provided in the control apparatus and calculates a position of the remote controller main body based upon a ultrasonic wave detection time at one speaker and a ultrasonic wave detection time at the other speaker.

### BEST MODE FOR CARRYING OUT THE INVENTION

Referring now to drawings, preferable embodiment modes of AV appliance operating systems according to embodiment modes of the present invent ion will be descried.

FIG. 2 is a block diagram for representing a schematic structure of an AV appliance which is employed in an AV appliance operating system according to an embodiment mode of the present invention. FIG. 3, is a block diagram for schematically showing an arrangement of a remote controller indicated in FIG. 2. FIG. 4 is a block diagram for schematically indicating an arrangement of a control apparatus shown in FIG. 2. FIG. 5 is an explanatory diagram for explaining ultrasonic waves outputted from speakers in response to pulse generations of the remote controller and response outputs thereof in a time axis. FIG. 6 is a frequency characteristic diagram for representing a use frequency range of the remote controller. It should be understood that the same reference numerals shown in FIG. 1 will be employed as those for denoting the same structural elements indicated in the drawings, and overlapped explanations thereof are omitted.

As shown in FIG. 2, an AV appliance operating system 100 according to an embodiment mode of the present invention is applied to an AV appliance 37, while the AV appliance 37 is equipped with a display unit (television receiver etc.) 31 and at least one pair of speakers 33 and 35. A control apparatus 39 is provided in the AV appliance 37, and can perform an input controlling operation by the GUI using the display unit 31. With respect to this control apparatus 39, operation signals can be inputted in a wireless communication by operating a remote controller main body 41.

As represented in FIG. 3, the remote controller main body 41 is arranged by a transmitting/receiving unit 43 and a control unit 45. The transmitting/receiving unit 43 is arranged by a light emitting unit 11, a light receiving unit 17, and an ultrasonic wave receiving unit 51. The light receiving unit 11 is constituted by an LED 7 and an LED driver 9. The light receiving unit 17 is constituted by a photodiode 13 and a receiving amplifier 15. The ultrasonic wave receiving unit 51 is constituted by a microphone 47 and an amplifier 49. Also, the control apparatus 39 is arranged by a modulator 19, a pulse generating unit 53, a response outputting unit 55, a demodulator 21, and a detecting unit 57. The modulator 19 modulates transmission data so as to transfer the modulated transmission data to the light emitting unit 11. The pulse generating unit 53 outputs an infrared pulse at predetermined timing. The response outputting unit 55 outputs an infrared response signal in response to a detection of ultrasonic waves. The demodulator 21 demodulates a signal received by the light receiving unit 17 so as to convert the received signal into reception data. The detecting unit 57 detects a specific frequency from ultrasonic waves from the ultrasonic wave receiving unit 51 and then transfers an ultrasonic wave detection signal to the response output unit 55. In this embodiment, the light emitting unit 11, the modulator 19, the light receiving unit 17, and the demodulator 21 constitute an infrared communication apparatus 1.

As shown in FIG. 4, the control apparatus 39 is equipped with the infrared communication apparatus 1 in order that the control apparatus 39 is communicated with the remote controller main body 41 in an infrared communication manner. The infrared communication apparatus 1 is arranged by a transmitting/receiving unit 3 and a control unit 5. The transmitting/receiving unit 3 is arranged by the light emitting unit 11 and the light receiving unit 17. The light emitting unit 11 is constituted by the LED 7 and the LSD driver 9. The light receiving unit 17 is constituted by the photodiode 13 and the reception amplifier 15. Also, the control unit 5 is arranged by the modulator 19 and the demodulator 21. The modulator 19 modulates transmission data and transfers the modulated transmission data to the light receiving unit 11. The demodulator 21 demodulates a signal received by the light receiving unit 17 and converts the demodulated signal into reception data. As a result, the control apparatus 39 and the remote controller main body 41 can be operated in a wireless manner by way of the infrared communication apparatuses 1 and 1, which are provided in both the control apparatus 39 and the remote controller main body 41.

In addition, the control apparatus 39 is equipped with a main control unit 61, an ultrasonic wave outputting unit 63, a calculating unit 65, and a graphic control unit 67 in addition to the above-described units. The main control unit 61 is connected to the control unit 5 of the infrared communication apparatus 1 and also to the light receiving unit 17, so that an infrared pulse derived from the remote controller main body 41 is inputted into the main control unit 61 which can control operations of the AV appliance 37 in a unification manner. The ultrasonic wave output unit 63 is connected to the main control unit 61, and sequentially outputs ultrasonic waves from one pair of the speakers 33 and 35 in response to the input of the infrared pulse. An ultrasonic wave has frequencies outside a human audio-frequency range. The calculating unit 65 calculates a position of the remote controller main body 41 based upon an ultrasonic wave detection time in one speaker 33 and an ultrasonic wave detection time in the other speaker 35. The graphic control unit 67 generates a predetermined character picture signal in response to an instruction issued from the main control unit 61, and superimposes the generated character picture signal on a picture signal, and then, supplies the superimposed picture signal to the display unit 31.

In the case that the AV appliance 37 containing the above-described arrangement is installed in, for example, a living room, one pair of the speakers 33 and 35 are arranged by sandwiching the display unit 31. Generally speaking, an audience views AV contents at a vertex of a triangle, while the speakers 33 and 35 are positioned on a bottom edge of the triangle. Under such a condition, in the AV appliance operating system 100 according to the present embodiment mode, since the control apparatus 39, the speakers 33 and 35, and the remote controller main body 41 are operated in a linkage manner, the remote controller main body 41 itself may function at an input unit of the pointing device.

In other words, while the remote controller main body 41 functioning as the pointing device is operated, as represented in FIG. 5, an infrared pulse “P1” is transmitted from the remote controller main body 41 in a periodic manner. The pulse P1 is generated by the pulse generating unit 53 of the remote controller main body 41, and then, the generated infrared pulse P1 is emitted from the light emitting unit 11. In contrast thereto, when the pulse P1 emitted from the remote controller main body 41 is received by the light receiving unit 17, the control apparatus 39 outputs a light reception signal to the control unit 61, and sends out an ultrasonic wave output control signal to the ultrasonic wave output unit 63, since this ultrasonic output control signal is inputted to the ultrasonic output unit 63, the ultrasonic wave output unit 63 sequentially outputs ultrasonic pulses P2 and P3 from the right and left speakers 33 and 35, while the ultrasonic pulses P2 and P3 have frequencies outside the human audio-frequency range.

When the pulses P2 and P3 outputted from the speakers 33 and 35 are detected by the microphone 47, the remote controller main body 41 outputs ultrasonic detecting signals via the input amplifier 49 and the ultrasonic detecting unit 57 to the response outputting unit 55. In response to inputting of the ultrasonic detection signal, the response outputting unit 55 outputs response signals via the light emitting unit 11 by employing infrared pulses “P2Re” and “P3Re”, while the response signals indicate that the ultrasound is detected.

In the control apparatus 39, the calculating unit 65 calculates an ultrasonic wave detection time “t1” and another ultrasonic wave detection time “t2.” The ultrasonic wave detection time “t1” is defined after the pulse “p2” is outputted until the infrared pulse “F2Re” transmitted from the remote controller main body 41 is received. The ultrasonic wave detection time “t2” is defined after the pulse “P3” is outputted until the infrared pulse “P3Re” transmitted from the remote controller main body 41 is received. The calculating unit 65 calculates distances from the speakers 33 and 35 up to the remote controller main body 41 based upon these times “t1” and “t2” and a sound velocity known in this technical field, and a distance between the speakers 33 and 35 is known. As a result, coordinate positions of the remote controller main body 41 may be calculated by a trigonometrical survey.

In this case, as indicated in FIG. 6, the ultrasonic waves outputted from the ultrasonic wave outputting unit 63 are transmitted by utilizing such a reproducing range where no output is present, which exceeds the audio-frequency ranges of one pair of the speakers 33 and 35. In other words, usually, a high fidelity speaker system has a reproducing range (namely, refer to frequency characteristic of speakers of FIG. 6) which exceeds an audio-frequency range (namely, refer to frequency characteristic of contents shown in FIG. 6). In order to firmly cover a reproducing range as a speaker, generally speaking, such a reproducing range is conducted.

On the other hand, in digital sound sources such as CDs and DVDs, although the digital sound sources contain flat frequency characteristics, sound outputs are not present by steep filters while a certain frequency constitutes a boundary. In this AV appliance operating system 100, since such a non-used frequency is utilized, a low-cost pointing device can be realized by utilizing the existing speakers 33 and 35.

The coordinate positions of the remote controller main body 41 which are acquired in the above-described manner are outputted to the main control unit 61, and thereafter, are supplied to the graphic control unit 67, so that pointing operation by the GUI is performed toy moving the remote controller main body 41 itself. In other words, a pointer is moved on the screen of the display unit 31 based upon x and y displacement information supplied from the remote controller main body 41, and when an enter command is supplied from the remote controller main body 41 at a position where a certain button frame image is indicated, a command code corresponding to this entered operation-purpose image is read out, and then, is outputted from the light emitting unit 11.

While the main control unit 61 waits for checking whether or not the remote controller main body 41 is received, for example, if a commander signal is transmitted from the remote controller main body 41 since the remote controller main body 41 is moved by the user, or an enter operation key is depressed by the user, then the main control unit 61 commences to display the operation-purpose image via the graphic control unit 67,

While the main control unit 61 judges whether or not a signal transmitted from the remote controller main body 41 is received, in such a case that the main control unit 61 judges that the signal transmitted from the remote controller main body 41 is received, the main control unit 61 judges that the inputted signal is an enter command. In this case, when the main control unit 61 judges that the inputted signal is not the enter command, the x displacement information and y displacement information are entered, so that the pointer is moved on the screen based upon the x and y displacement information. In an actual case, this control operation becomes such a display that the pointer is moved on the screen.

As to this motion process operation, the main control unit 61 transmits data to the graphic control unit 67 in such a manner that a new position of the pointer is calculated in response to the x and y displacement information, and then, the pointer is moved to this calculated new position on the screen so that the main control unit 61 realizes the movement of the pointer on the display.

As previously described in detail, the AV appliance operating system 100, according to the present embodiment mode, corresponds to such an AV appliance operating system 100 having a remote controller main body 41 which can be operated in a wireless manner by infrared communication apparatuses 1 provided in both a control apparatus 39 and an AV appliance 37, the AV appliance 37 being equipped with display unit 31, at least one pair of speakers 33, 35, and the control apparatus 39 for performing an input control operation by GUI (graphic user interface) with employment of the display unit 31, in which the AV appliance operating system 100 is comprised of: a pulse generating unit 53 provided in the remote controller main body 41, for outputting an infrared pulse at predetermined timing: a ultrasonic wave outputting unit 63 provided in the control apparatus 39, for sequentially outputting ultrasonic waves having frequencies outside a human audio-frequency range from the one pair of speakers 33, 35, in response to an input of the infrared pulse; a response outputting unit 55 provided in the remote controller main body 41, for outputting an infrared response signal in response to a detection of the ultrasonic waves; and a calculating unit 65 provided in the control apparatus 39, for calculating a position of the remote controller main body 41 based upon a ultrasonic wave detection time t1 at one speaker and a ultrasonic wave detection time t2 at the other speaker.

As a consequence, while the speakers 33 and 35 which are generally used in the existing AV appliance 37 and the remote controller main body 41 are used, the infrared rays are combined with the ultrasonic waves, so that the position of the remote controller main body 41 is detected, and the input operation with respect to the GUI can be carried out based upon the move information of this remote controller main body 41.

As a result, it is possible to obtain the low cost pointing device which can be operated under low power consumption and also can be properly operated in correspondence with the GUI of the AV appliance 37.

The above-described embodiment mode is described such a case that only one pair of the speakers 33 and 35 are installed. Alternatively, the AV appliance operating system according to the present invention may be applied to such an AV appliance that a center speaker is installed on a plane which is different from the same plane where one pair of the speakers 33 and 35 are installed. With employment of such an alternative arrangement, ultrasonic waves nay also be outputted from the center speaker in addition to one pair of the speakers 33 and 35; ultrasonic wave detection times at one pair of these speakers 33 and 35, and an ultrasonic wave detection time at this center speaker may be calculated by the calculating unit 65, so that a three-dimensional pointing operation may be alternatively realized.

### BRIEF DESCRIPTION OF THE DRAWINGS

FIG. 1 is a block diagram for showing the schematic arrangement of the conventional infrared communication apparatus.

FIG. 2 is a block diagram for showing a schematic arrangement of an AV appliance which is employed in an AV appliance operating system according to an embodiment mode of the present invention.

FIG. 3 is a block diagram for indicating a schematic arrangement of a remote controller shown in FIG. 2.

FIG. 4 is a block diagram for representing a schematic arrangement of a control apparatus shown in FIG. 2.

FIG. 5 is an explanatory diagram in which ultrasonic wave outputs from speakers in response to pulse generations of the remote controller, and response outputs thereof are expressed in a time axis.

FIG. 6 is a frequency characteristic diagram for representing use frequency ranges of the remote controller.

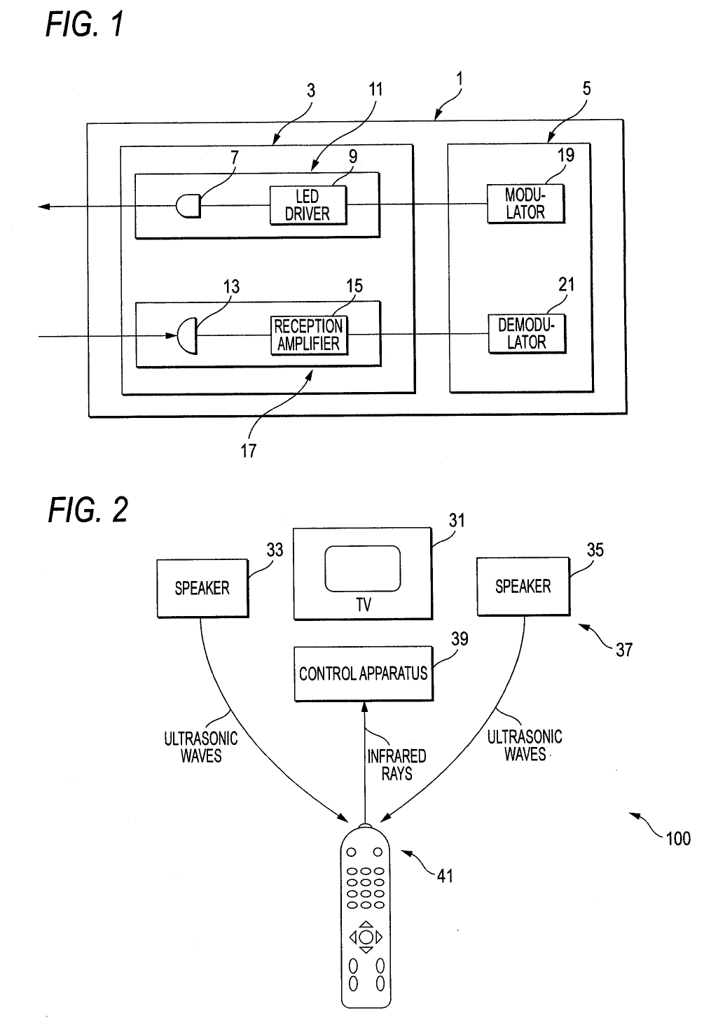

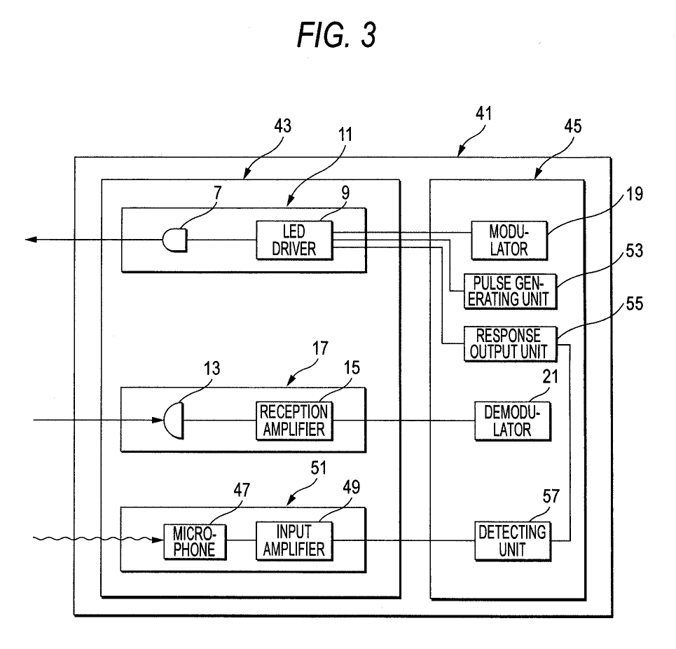

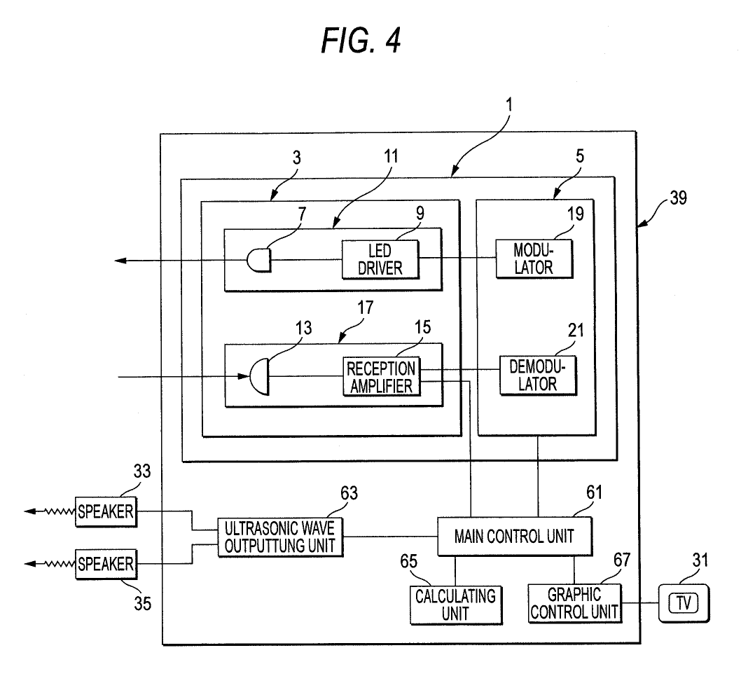

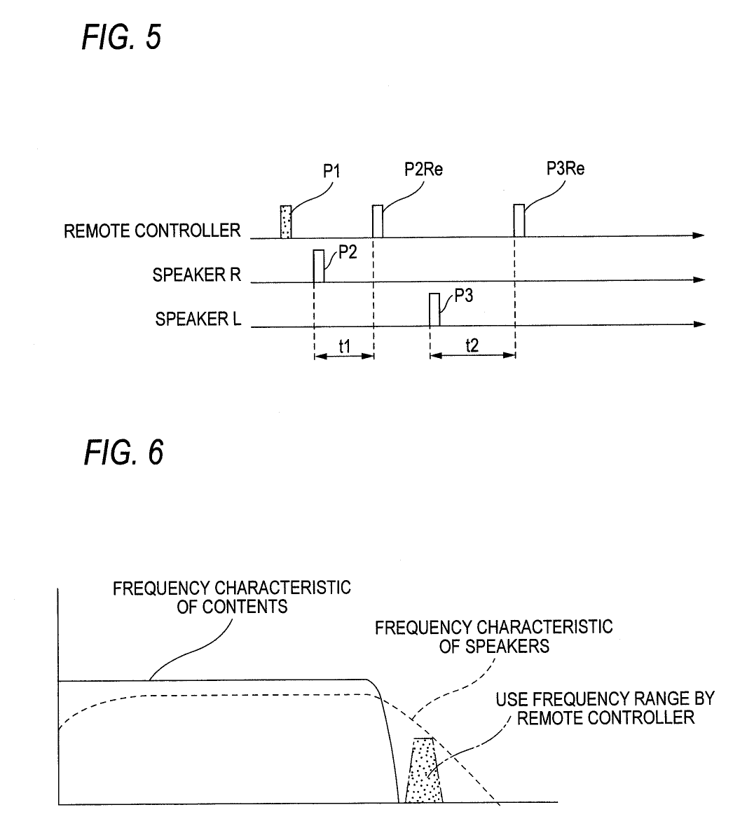

### DESCRIPTION OF REFERENCE NUMERALS AND SIGNS

1 infrared communication apparatus
31 display unit
33, 35 one pair of speakers
37 AV appliance
39 control apparatus
41 remote controller main body
53 pulse generating unit
55 response outputting unit
63 ultrasonic wave outputting unit
65 calculating unit
100 AV appliance operating system
t1, t2 ultrasonic wave detection time

1. AV appliance operating system comprising;
a remote controller main body which can be operated in a wireless manner by infrared communication apparatuses provided in both a control apparatus and an AV appliance, the AV appliance being equipped with a display unit, at least one pair of speakers, and the control apparatus for performing an input control operation by GUI with employment of the display unit;
the AV appliance operating system comprising:
a pulse generating unit that is provided in the remote controller main body, and outputs an infrared pulse at predetermined timing;
a ultrasonic wave outputting unit that is provided in the control apparatus, and sequentially outputs ultrasonic waves having frequencies outside a human audio-frequency range from the one pair of speakers in response to an input of the infrared pulse;
a response outputting unit that is provided in the remote controller main body, and outputs an infrared response signal in response to a detection of the ultrasonic waves;
a calculating unit that is provided in the control apparatus, and calculates a position of the remote controller main body based upon a ultrasonic wave detection time at one speaker and a ultrasonic wave detection time at the other speaker; and
a movement processing unit that moves a pointer of the GUI displayed on the display unit over the display unit based upon the position of the remote controller main body, which is calculated by the calculating unit.

2. The AV appliance operating system according to claim 1, wherein:
the ultrasonic waves outputted from the ultrasonic wave output unit are outputted by utilizing such a reproducing range where the output of the ultrasonic waves is not present, which exceeds the audio-frequency range of the one pair of speakers.

3. The AV appliance operating system according to claim 1 further comprising a center speaker installed on a plane which is different from the same plane where the one pair of speakers are installed, wherein the ultrasonic waves are outputted from the center speaker, and the ultrasonic wave detection times at the one pair of speakers, and also a ultrasonic wave detection time at the center speaker are calculated by the calculating unit so as to detect the position of the remote controller main body.
